(19) United States
(12) Patent Application Publication
(10) Pub. No.: US 2007/0073581 A1
(43) Pub. Date: Mar. 29, 2007

(54) System and method for delivering pay for performance advertising in conjunction with distributed media content

(75) Inventors: Andrew Kempe, London (GB); Simon Broadley, London (GB)

Correspondence Address: TIMOTHY P. O'HAGAN, 8710 KILKENNY CT, FORT MYERS, FL, 33912, US

(73) Assignee: Miva, Inc., Fort Myers, FL (US)

(21) Appl. No.: 11/236,460

(22) Filed: Sep. 27, 2005

(51) Int. Cl. G06Q 30/00

(52) U.S. Cl. 705/14

(57) ABSTRACT

An advertising system provides content relevant advertisements to a client system for rendering in association with an instance of distributed content. The advertising system comprises a web server receiving content requests and redirect requests from the client system. Each content request includes: i) a unique identifier distinguishing the instance of distributed content from other instances of distributed content; ii) a template identifier identifying predetermined image map attributes of a predetermined image map defined within the distributed content; and ii) a search parameter. An advertisement content rendering object receives each content request and in response thereto, returns a rendering of each of a plurality of instances of advertising content in accordance the image map attributes associated with the template identifier. A redirect database maintains, in association with the unique identifier, redirect data and a financial parameter associated with each instance of advertising content. Each redirect request comprises: i) the unique identifier distinguishing the instance of distributed content from other instances of distributed content; and ii) an identification of a zone of an image map defined within the distributed content that is selected by a user. A redirect object receives each redirect request and in response thereto: i) looks up the redirect data associated with both the unique identifier and the identified zone of the image map; and ii) directs the client system to a URL associated with the redirect data.

### TECHNICAL FIELD

The present invention relates to a system and method for providing pay for performance advertising in conjunction with distributed media content such as email and, more particularly to a method for providing pay for performance advertising in conjunction with distributed media content in a manner that does not require placement of a cookie on a client device.

### BACKGROUND OF THE INVENTION

Placement of content relevant advertising in web published media content has existed for several years. For example, US Published Application 2004/0093327 to Anderson et al, discloses a system where an HTML web document publisher may include IFRAMES and JavaScript within a web document that effectively obtains an advertisement from an advertisement system. The advertisement system analyzes content of the web document to select an advertisement relevant to the web document.

It has also been proposed to include content relevant advertisements in distributed media content such as HTML email messages.

However, the teachings of Anderson et al. are of little use for placing advertisements within HTML email messages because many web-based email systems strip out IFRAMES and JavaScript before delivery to a user's system for display. This precludes use of JavaScript and IFRAMES from retrieving advertisement content for combination with and display within the HTML email content.

US Published Application 2005/0076051 to Carobus et al. describes a system for serving content targeted ads in email that does not relay on IFRAMEs or JavaScript.

Carobus et al. requires that the publisher of the email make the email content of an email available to the Carobus et al. system in advance of sending the emails. In return, an HTML snippet is obtained from the Carobus et al. system for inclusion in each email sent by the publisher.

The HTML snippet includes a URL to which an impression request can be made and which is uniquely associated with the content that was previously made available to the Carobus et al. system.

When a client email system opens the email, an impression request is made to a URL identified in the HTML snippet. In response to the impression request, the advertising server: i) looks up previously registered content; ii) builds and returns a monolithic image including multiple relevant advertisements; and iii) assigns and returns a unique session ID. The session ID is returned as a cookie.

A protocol buffer is a list of rectangular regions in the ad image and defines a redirect URL for each rectangular region. When a user “clicks” a rectangular region, the cookie, including the unique session ID is returned to the server to allow the server to determine which ad was selected and return a redirect URL to a landing page associated with the selected advertisement.

In the case of a server side image map implementation, the cookie defines each rectangular region. In the case of a client side image map, each rectangular region may be assigned a numerical index.

A key problem associated with Carobus et. al. solution is that the unique identifier assigned by the advertisement server is delivered to the email client as a cookie. Cookies are becoming increasing unpopular because of security concerns and cookies and often being blocked.

An alternative embodiment suggested by Carobus et al. works in generally the same manner but, instead of the advertising server assigning a unique session ID, each email sent by the publisher is assigned a globally unique ID number (a GUID). The advertisement server stores a record for each GUID of each email—which, as Carobus et al. points out, has the disadvantage of require a very large and very long-to-live cache.

What is needed is a system and method for providing content relevant advertising in conjunction with distributed media content, such as email, that does not suffer the disadvantages of known systems. More specifically, what is needed is a system and method for providing content relevant advertising that does not require placement of a cookie on the client system and a system and method that does not require a database of each unique identifier of each distributed email.

### SUMMARY OF THE INVENTION

A first aspect of the present invention comprises an advertising system for providing content relevant advertisements to a client system for rendering in association with an instance of distributed content.

The system comprises a web server receiving HTTP connection requests from client systems. The connection requests are content requests and redirect requests. Each content request comprises: i) a unique identifier distinguishing the instance of distributed content from other instances of distributed content; ii) a template identifier identifying predetermined image map attributes of a predetermined image map defined within the distributed content; and ii) a search parameter.

The unique identifier distinguishing the instance of distributed content from other instances of distributed content may comprise a combination of: i) an affiliate identifier unique to an affiliate generating each instance of the distributed content; ii) an affiliate generated campaign identifier; and iii) an affiliate generated instance identifier distinguishing the instance of distributed content from other instances of distributed content generated by the affiliate as part of the same campaign.

The search parameter may be a search word related to the distributed content or a search category representing at least two search words related to the distributed content.

Each redirect request comprises: i) the unique identifier distinguishing the instance of distributed content from other instances of distributed content; and ii) an identification of a zone of an image map defined within the distributed content that is selected by a user.

An advertisement content rendering object receives each content request and in response thereto passes the search parameter to a placement object. A plurality of instances of advertising content associated with the search parameter are received back from the placement object.

The advertisement content rendering object returns, to the client system, a rendering of each instance of the plurality of instances of advertising content in accordance the image map attributes associated with the template identifier.

A redirect database maintains, in association with those unique identifiers received in a content request, redirect data and a financial parameter associated with each instance of advertising content. Also stored in association with each instance of advertising content is an indication of the one or more, zones of the image map with which the instance of redirect data is associated.

The advertisement content rendering object writes, to the redirect database, the unique identifier received in a content request and, in association therewith, the redirect data and financial parameter associated with each instance of advertising and the zone associated with each instance of redirect data.

A redirect object receives each redirect request and in response thereto: i) looks up the redirect data associated with both the unique identifier and the identified zone of the image map; and ii) directs the client system to a URL associated with the redirect data.

In one sub embodiment, one instance of the advertising content may be associated with (or positioned within) multiple zones of the image map. In which case, the redirect data that is associated with such instance of advertising content is associated, in the redirect database, with each zone in which such instance of advertising content is associated or positioned.

In another sub embodiment, each instance of advertising content may be rendered as an instance of text advertisement content within one or more zones of the image map. In such embodiment, the template identifier may further identify rendering attributes including at least one of text font, font size, font color, and background color.

The advertisement content rendering object renders each instance of the text advertisement content in accordance with the rendering attributes in a portion of a single image corresponding to one or more active zones of the image map.

For a better understanding of the present invention, together with other and further aspects thereof, reference is made to the following description, taken in conjunction with the accompanying drawings. The scope of the present invention is set forth in the appended claims.

### BRIEF DESCRIPTION OF THE DRAWING

FIG. 1 is diagram representing architecture of a system for providing pay for performance advertising in conjunction with distributed media content in accordance with one embodiment of the present invention;

FIG. 2a is a diagram representing instances of text advertisement content overlaying an image map in accordance with one embodiment of the present invention;

FIG. 2b is a diagram representing instances of graphic advertisement content overlaying an image map in accordance with one embodiment of the present invention;

FIG. 3a is a diagram representing exemplary table structure for relating search categories to search words in accordance with one embodiment of the present invention;

FIG. 3b is a diagram representing exemplary table structure for relating search words to advertisement content in accordance with one embodiment of the present invention;

FIG. 4 is a diagram representing an exemplary rendering template in accordance with one embodiment of the present invention;

FIG. 5 is a diagram representing exemplary table structure for relating redirect data with unique identification of an instance of the distributed content;

FIG. 6 is a flow chart representing exemplary operation of an advertisement content rendering object in accordance with one embodiment of the present invention;

FIG. 7 is an exemplary image template table in accordance with one embodiment of the present invention; and

FIG. 8 is a flow chart representing exemplary operation of a redirect request module in accordance with one embodiment of the present invention.

### DETAILED DESCRIPTION OF THE EXEMPLARY EMBODIMENTS

The present invention will now be described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should also be appreciated that many of the elements discussed in this specification may be implemented in a hardware circuit(s), a processor executing software code, or a combination of a hardware circuit(s) and a processor or control block of an integrated circuit executing machine readable code. As such, the term circuit, module, server, or other equivalent description of an element as used throughout this specification is intended to encompass a hardware circuit (whether discrete elements or an integrated circuit block), a processor or control block executing code, or a combination of a hardware circuit(s) and a processor and/or control block executing code.

It should also be appreciated that table structures represented in this application are exemplary only and intended to show the mapping of relationships between various data elements. Other table structures may store similar data elements in a manner that maintains the relationships useful for the practice of the present invention.

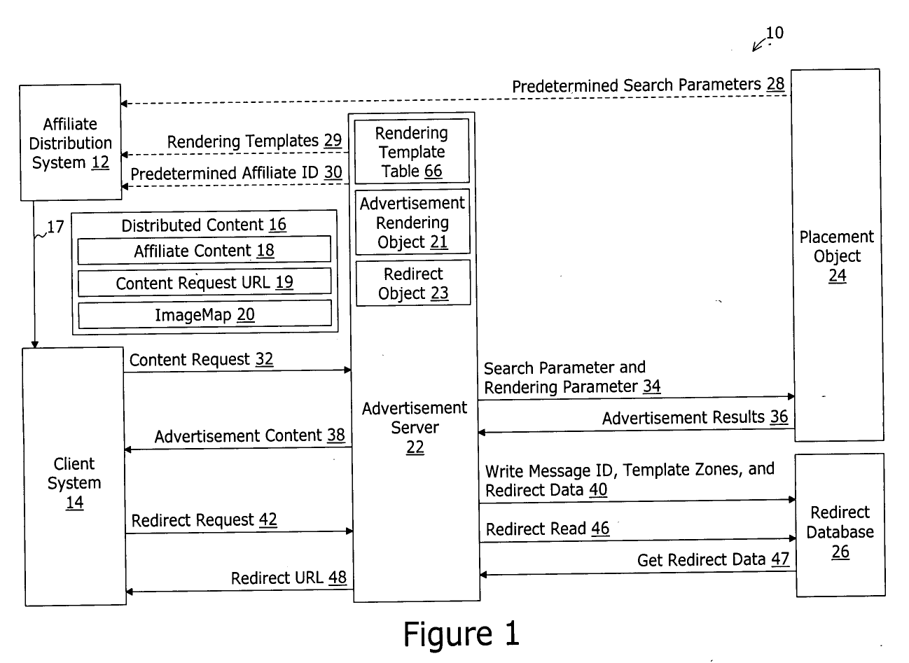

FIG. 1 represents architecture 10 of a system for placement of pay for performance advertising within distributed content 16—such as email. The system includes an advertisement server 22, a redirect database 26, and a placement object 24—which operate in conjunction with a an affiliate distribution system 12 and the client system 14.

FIG. 1 represents the advertisement server 22, the placement object 24, and the redirect database 26 as distinct boxes for purposes of facilitating discussion of the functions of the present invention. Those skilled in the art will appreciate that the functions of the advertisement server 22, placement object 24, and redirect database 26 are readily implemented: i) on a single hardware server; ii) on multiple interconnected hardware servers with each of the advertisement server 22, placement object 24, and redirect database 26 being implemented on one or more distinct hardware servers; or iii) on multiple interconnected hardware server's with functions of each of the advertisement server 22, placement object 24, and redirect database 26 distributed across each of the multiple hardware servers.

In general, the affiliate distribution system 12 distributes an instance of distributed content 16 to the client system 14 as represented by step 17. The instance of distributed content 16 includes the affiliate's media content (affiliate content 18) as well as an advertisement content request URL 19 and an image map 20.

When the client system 14 opens the distributed content 16, in accordance with the teachings herein, the client system 14: i) opens an HTTP connection to the advertisement server 22 using the advertisement content request URL 19 and receives advertisement content back from the advertisement server 22 linking to the image map 20 such that when the user interacts with the rendered advertisement, such as by clicking within an active zone of the image map 20 linked to the advertisement content, the client system 14 is directed to an advertiser's landing page.

In one aspect of the present invention, the affiliate, controlling the distribution system 12, may control the quantity of instances of advertisement content rendered within the distributed content 16 and the way in which each instance of advertisement is rendered. For example, the pay for performance advertising may be rendered within distributed content 16 in a plurality of ways including, but not limited to: i) text of one or more instances of advertisement content, each coinciding with one or more active zones of an image map such that when the user clicks on the active zone, the client system 14 is linked to the landing page of the advertiser; ii) one or more instances of graphical advertisement content, each coinciding with one or more active zones of an image map such that when the user clicks on the active zone, the client system 14 is linked to the landing page of the advertiser; iii) an instance of motion video advertisement content (with or without corresponding audio) coinciding with one or more active zones such that when the user clicks on the active zone the client system 14 is linked to the landing page of the advertiser; iv) an instance of audio content and an icon associating the audio content to an active zone such that when the user clicks on the active zone, the client system 14 is linked to the landing page of the advertiser; and v) any of the text advertisement content, graphic advertisement content, and motion video content rendered in an active pop-up window such that when the user clicks on the pop-up window, the client system 14 is linked to the landing page of the advertiser.

The affiliate chooses such rendering attributes by choosing a one of a plurality of predetermined rendering templates that includes rendering attributes and template attributes which correspond to the attributes desired by the affiliate.

Referring briefly to the rendering template table 66 of FIG. 7 in conjunction with FIG. 1, each a plurality of predetermined rendering templates 64 may define, in a manner different from the other rendering templates: i) rendering attributes 67 defining the rendering of one or more instances of advertising content within the distributed content 16; and ii) image map attributes 69 defining the image map 20 for rendering within the distributed content 16 and enabling the user to interact with the rendered advertising content.

The rendering attributes 67 may include: i) an indicator that the instance(s) of advertisement content are to be rendered as text, graphics, audio, motion video, or other format; and ii) in a situation wherein the particular format permits further rendering variables, the further rendering variables. For example, if rendering of advertisement content as text, the further rendering variables may include the background color, font, font size, font color, and borders for each instance of text advertisement content.

The image map attributes 69 may include the overall size of the image map 20 and each active region. Each active region may be defined, for example, by two coordinates and an active zone height and width defining a rectangle, coordinates and dimensions defining a polygon, or two coordinates and a radius defining an ellipse.

In an example where an affiliate chooses to render advertisements as text advertisement content, the affiliate may select a rendering template 64 that defines a desired: i) number of instances of text advertisement content to be rendered; ii) size and shape of each instance of text advertisement content (and a corresponding active zone of an image template); and iii) background color, font, font size, font color, and borders for each instance of text advertisement content.

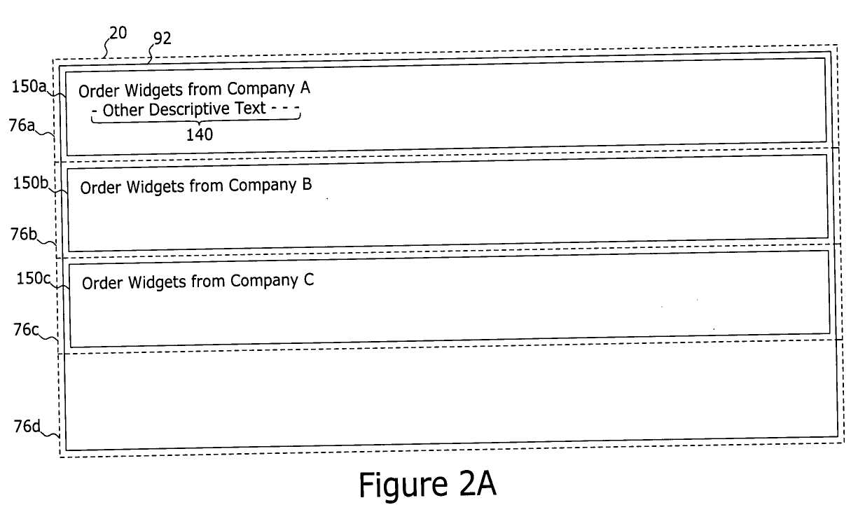

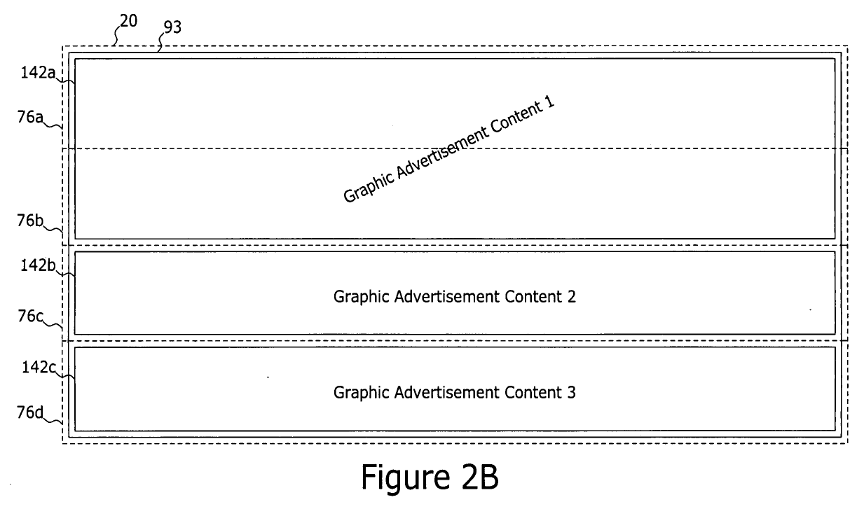

FIG. 2a represents an exemplary rendering of three instances of text advertisement content 150a-150c, each coinciding with one of a total of four active zones 76a-76d of an image map 75 (shown in dashed line). Each instance of text advertisement content 150a-150c may include the advertiser's text content 140 rendered in a template specified text font, text color, font size, background color, and boarder.

Each of the three instances of text advertisement content 150a-150c corresponds to an active zone 76a-76c respectively. In this example, there is no advertisement associated with the active zone 76d and therefore a region of blank space or dummy advertisement corresponds to active zone 76d. The three instances of text advertisement content 150a-150c and the blank space or dummy advertisement are combined and rendered in a single image file 92 (for example a .jpg file or .png file) with an overall size of the image map 75 for rendering with image map 75.

It should be appreciated that, for purposes of clarity, FIG. 2a shows the image 92 slightly smaller and inside the image map 75, but that is for distinguishing the elements in the drawing only. In rendering within document, the upper left corner of the image 92 and the image map 75 will coincide.

As another example, if the affiliate chooses to render graphic image advertisements, the affiliate may select a rendering template 64 that defines a desired: i) number of instances of graphic advertisement content to be rendered; and ii) size and shape of each zones in which the graphic content is to be rendered (and a correspond active zone(s) of an image template.

FIG. 2b represents an exemplary rendering of three instances of graphic advertisement 142a-142c, each coinciding with one or more of four active zones 76a-76d of an image map 75. In this example, a first instance of graphic advertisement content 142a occupies both the first zone 76a and the second zone 76b. A second and third instance of graphic advertisement content 142b and 142c each occupy a single zone, 76c and 76d respectively.

Returning to FIG. 1, step 29 represents the affiliate selecting one of a plurality of predetermined rendering templates 64. Step 29 is shown as a dashed line to indicate that such selection may be automated or may be manually handled between representatives of the company controlling the affiliate distribution system 12 and representatives of the company controlling the advertising server 22 and/or placement object 24.

Another aspect of the present invention is the use of predetermined search parameters to associate affiliate content 18 with advertisers selling products or services related to the affiliate content 18.

The affiliate controlling the affiliate distribution system 12 selects a search parameter relevant to the affiliate content 18 from a plurality of predetermined search parameters maintained by the placement object 24. Each search parameter may be a search word or a category ID representing a plurality of predetermined search words.

Each of multiple advertisers may associate a bid amount with those predetermined search words (or categories) that relate to the advertiser's products or services. The affiliate's selection of one of a plurality of predetermined search parameters and its inclusion in the distributed content 16 eliminates any need for the affiliate to register or otherwise make the affiliate content 18 available to the advertisement server 22 or the company controlling the advertising server 22 and/or placement object 24.

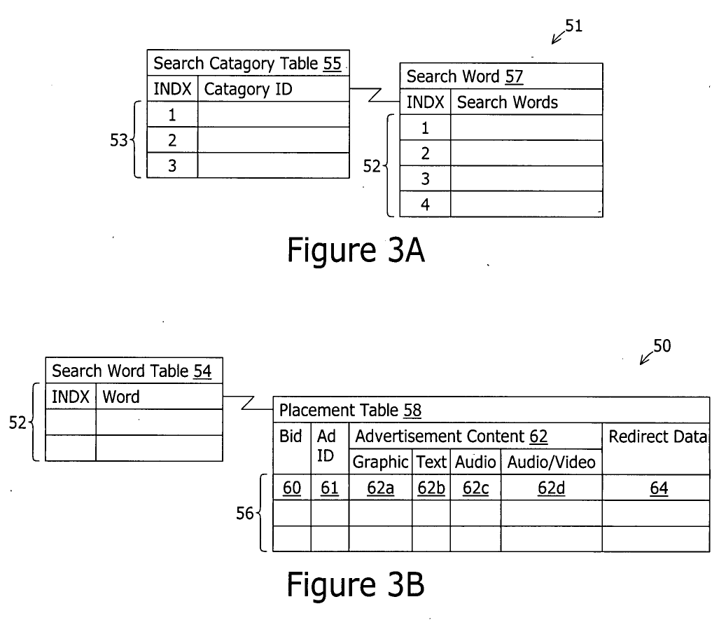

Turning briefly to FIG. 3a, an exemplary table structure 51 represents organization of predetermined search categories 53. Each search category 53 may be an alpha numeric value which is indexed in a search category table 55. Associated with each search category 53 are a plurality of search words 52—which may be stored in a search word table 57.

Turning briefly to FIG. 3b, an exemplary table structure 50 represents organization of the predetermined search words 52. Each search word 52 may be a key word which describes content and would logically be used by a person for performing a key word search.

Within the exemplary table structure 50, each search word 52 is indexed in a search word table 54. Associated with each search word 52 is placement information 56—which may be stored in a placement table 58. The placement information 56 includes, for each advertiser that elected to bid for the search word 52, the then current bid amount 60, an advertisement identifier 61, advertisement content 62, and a redirect URL 64. The advertisement content 62 may comprise different rendering formats of the advertisement content 62 such as a text rendering of the advertisement content 62a, a graphic rendering 62b, an audio rendering 62c, and a motion video rendering 62d.

Returning to FIG. 1, the affiliate selecting a predetermined search parameter for inclusion within distributed content 16 is represented by step 28. Step 28, like step 29, is shown as a dashed line to indicate that such selection may be automated or may be manually handled between representatives of the company controlling the affiliate distribution system 12 and representatives of the company controlling the placement object 24 and/or advertising server 22.

In general, when the instance of distributed content 16 is opened by the client system 14: i) the client system 14 opens an HTTP connection to the advertisement server 22 using the content request URL 19 (e.g. the content request at step 32); ii) the advertisement server 22 passes the search parameter selected by the affiliate to the placement object 24 (step 34); iii) the placement object 24 returns instances of advertisement content associated with the highest bidders for the search parameter (step 36); and iv) the advertisement server 22 renders the advertisement content in the format expected by the client system 14 for return to the client system 14 for rendering within the distributed content (step 38).

The content request (step 32) to the content request URL 19 includes information used by the advertisement server 22 to: i) identify the search parameter selected by the affiliate; ii) identify the rendering template 64 selected by the affiliate; and iii) uniquely distinguish the instance of the distributed content 16 from other instances of distributed content 16.

To build the content request URL 19 and the image map 20 for each instance of distributed content 16, the affiliate distribution system 12 “populates” values into an unpopulated content request URL and an unpopulated image map of the selected rendering template 64.

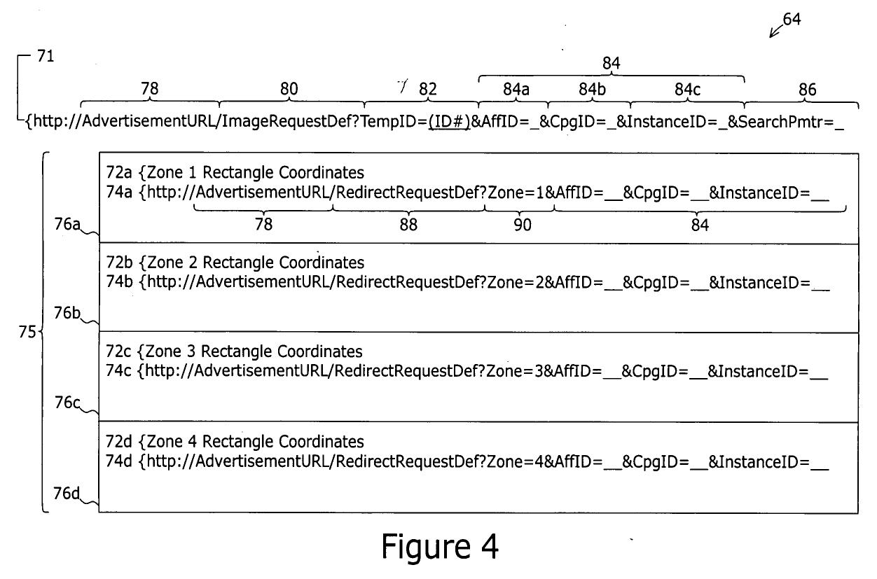

Turning to FIG. 4 in conjunction with FIG. 1, an exemplary rendering template 64 for a text or graphic visual display of instances of advertisement content is shown. This exemplary rendering template 64 includes the unpopulated content request URL 71 and the unpopulated image map 75.

The unpopulated content request URL 71 comprises a predetermined core URL 78, a predetermined URL extension 80, a predetermined template identifier 82, an unpopulated instance identifier 84, and an unpopulated search parameter identifier 86.

The predetermined core URL 78 is a URL recognizable by DNS servers to facilitate routing of an HTTP connection request using the content request URL 71 to the advertisement server 22. An example of a core URL 78 would be “imagelisting.miva.com”.

The predetermined URL extension 80 is a predetermined character string which serves as an indicator to the advertisement server 22 to process the HTTP connection request as a content request.

The predetermined template identifier 82 is the predetermined value that distinguishes the rendering template 64 from other rendering templates. The inclusion of the predetermined template identifier 82 within the content request URL 71 enables the advertisement server 22 to look-up, within the template table 66, the rendering attributes 67 and image map attributes 69.

The unpopulated instance identifier 84 identifies values, populated by the affiliate distribution system 12, which distinguish the instance of the distributed content 16 from other instances of the distributed content 16. The values populated by the affiliate distributions system 12 may include an affiliate ID 84a, a campaign ID 84b, and an instance ID 84c.

This structure enables the affiliate to assign its own locally generated campaign ID values 84b and its own locally generated instance ID value 84c so long as each affiliate has a unique affiliate ID 84a. This assures that (so long as the affiliate does not duplicate campaign ID values across multiple campaigns or instance ID values within a campaign) no instance identifier 84 (a combination of all of the affiliate ID 84a, the campaign ID 84b, and the instance ID 84c) is unique for each instance of distributed content 16. Typically, the instance ID 84c will be generated by: i) incrementing a counter for each instance of distributed content 16 in an email campaign; or ii) by using the destination email address for each instance of distributed content 16 in an email campaign). To assure that all affiliates have unique affiliate ID values, the affiliate may obtain a predetermined affiliate ID 84a value from the company controlling the advertisement server 22. Step 30 (FIG. 1) represents the affiliate obtaining a unique affiliate ID from the controller of the advertising server 22. As with steps 28 and 29, step 30 is shown in a dashed line to represent that the selection may be automated or may be manually handled between by representatives of the company controlling the affiliate distribution system 12.

The unpopulated search parameter identifier 86 identifies the one of the predetermined search parameters selected by the affiliate and populated by the affiliate distribution system 12.

In this example, the unpopulated image map 75 includes four active zones 76a-76d which are represented graphically as four active zones 76a-76d arranged in a single column and four rows. The unpopulated image map 75 includes, for each active zone 76a-76d, an active zone definition 72a-72d and an unpopulated redirect request URL 74a-74d.

Each active zone definition 72a-72d may be defined, for example, by two coordinates and an active zone height and width defining a rectangle, coordinates and dimensions defining a polygon, or two coordinates and a radius defining an ellipse.

Each unpopulated redirect request URL 74a-74d comprises the predetermined core URL 78, a predetermined URL extension 88, a predetermined zone identifier 90, and the unpopulated instance identifier 84.

Again, the predetermined core URL 78 facilitates routing of the HTTP connection request to the advertising server 22. The predetermined URL extension 88 is a predetermined character string which serves as an indication to the advertisement server 22 to treat the HTTP connection request as a redirect request.

The predetermined zone identifier 90 is a predetermined value identifying one of the active zones with which the redirect request URL 74a-74d is uniquely associated.

The unpopulated instance identifier 84 identifies values, populated by the affiliate distribution system 12, which distinguish the instance of the distributed content 16 from other instances of the distributed content 16. Again, the values populated by the affiliate distribution system 12 may include an affiliate ID 84a, a campaign ID 84b, and an instance ID 84c.

Returning to FIG. 1, once the affiliate has selected (or obtained) a search parameter (step 28), a rendering template 64 (step 29), and a predetermined affiliate ID value (step 30),—and entered those values into the affiliate distribution system 12, the affiliate distribution system 12 can commence building of distributed content 16 for distribution to each of a plurality of recipients—such as via an email campaign.

As discussed, when the client system 14 opens the instance of distributed content 16, the client system 12 initiates an HTTP connection request to the content request URL 19 (e.g. the content request at step 32). The core URL 78 assures that the HTTP connection request is routed to the advertisement server 22. The remainder of the predetermined template values and populated values in the content request URL 19 are useful by the advertisement server 22 to: i) identify the search parameter selected by the affiliate; ii) identify the rendering template 64 selected by the affiliate; iii) and uniquely distinguish the instance of the distributed content 16 from other instances of distributed content.

The advertisement server 22 passes the search parameter to the placement object 24 and receives advertisement results in response as represented by steps 34 and 36. The advertisement response includes advertisement content 62 for a plurality of advertisements as needed for rendering and returning one or more instances of advertising content to the client system 14.

The advertisement server 22 may also pass a rendering parameter to the placement object 24 which identifies the rendering format (e.g. graphic image, text, audio, motion video etc). In which case, the placement object 24 may return the advertisement content 62 in only the rendering formats (62a-62d) needed by the advertisement server 22. The advertisement response also includes redirect data associated with each advertisement. Redirect data includes: i) a redirect URL to which the client system is to be redirected in the event the user selects the advertisement; and/or ii) information useful for looking up, determining, or requesting (for example requesting from the placement object 24) a redirect URL to which the client system is to be redirected in the event the user selects the advertisement. The advertisements returned are for those advertisers who bid highest for the search parameter. The redirect data returned by the placement object may include a financial parameter which may be: i) a bid parameter such as a bid amount associated with the advertisement; and/or ii) information useful for looking up, determining, or requesting (for example requesting from the placement object 24) a bid amount or other compensation scheme associated with the advertisement, the user's selection of the advertisement, and/or a commercial transaction associated with the advertisement.

The advertisement server 22 renders the returned advertisement content at step 126. Rendering the advertisement content includes assuring that the advertisement content to be returned to the client system 14 complies with the rendering 67 attributes and the image map attributes 69 associated with the affiliate selected rendering template 64.

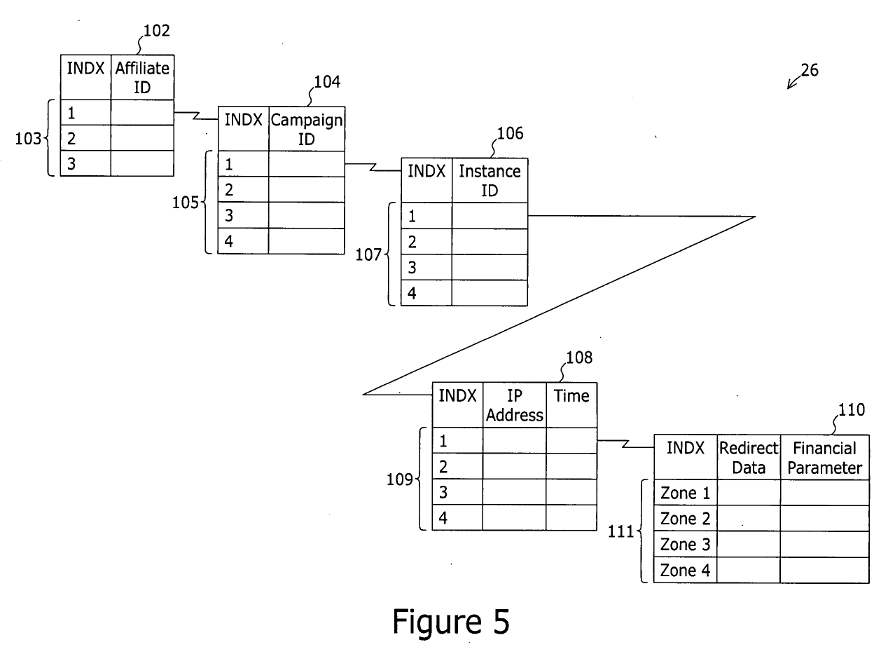

The advertisement server 22 also writes the redirect data and financial parameter associated with each advertisement to the redirect database 26, an exemplary structure of which is shown in FIG. 5.

The exemplary redirect database 26 includes an affiliate ID table 102, a campaign ID table 104, an instance ID table 106, an ID address table 108, and a redirect table 110.

The affiliate ID table 102 is an index table with each record 103 storing the unique affiliate ID assigned to an affiliate controlling an affiliate distribution system 12. The campaign ID table 104 keys to a record of the affiliate ID table 102 and each record 105 of the campaign ID table stores a campaign ID value. The instance ID table 106 keys to a record of the campaign ID table 104 and each record 107 stores an instance ID value. The IP address table 108 keys to a record of the instance ID table 106 and each record 109 stores a IP address extracted from the content request made by the client system 14 and a time value. The redirect table 110 includes a plurality of records 111, each of which maps one of the zones 76a-76d of the image map 20 to the redirect data and the financial parameter associated with the advertisement content rendered within such zone.

It should be appreciated that storing an extracted IP address may be used to distinguish between content request URL's coming from different client systems 14, but having the same instance identifier because the distributed content 16 was forwarded from one client system to another client system. Although this solution does not enable the advertisement server 22 to distinguish between two clients that share an IP address (if behind the same network address translation device for example), it eliminates the detrimental results of client confusion (e.g. one client being redirected to landing pages for advertisements rendered for another client) in all except those few rare cases where the two clients share the same IP address and the two clients open the distributed content, obtain advertisement renderings that are different, and select a rendered advertisements within a specific temporal order.

In this exemplary structure, the affiliate ID table 102 is relatively static in that records are only added, modified, or deleted when affiliate ID values—which are assigned to an affiliate are added, modified, or deleted.

A campaign ID value may be written to the campaign ID table if, and when, a content request is received from a client system 12 that includes a campaign ID value associated with an affiliate ID value that does not already exist in the campaign ID table 104 associated with the affiliate. Campaign ID values may be removed after a predetermined period of time (e.g. a time to live value).

It should be appreciated that, although useful, the campaign ID 84b is optional. If an affiliate system implements a system for assigning a unique instance ID 84c to each email (across multiple campaigns), there is not need for the campaign ID 84b. A new record in the instance ID table 106 and IP address table 108 is written each time a content request is received from a client system 12. Instance ID values may be removed after a period of time to prevent the database from becoming large. A new redirect table 110 is also written each time a content request is received from a client system 12 and populated with a record associating each zone of the image map with the redirect data and financial parameter associated with the advertisement content rendered in such zone.

If multiple content requests are received with the same unique identifier (for example if one email is opened multiple times) each is written to the database and upon receipt of a redirect request, the most recent is used.

Returning to FIG. 1 in conjunction with FIG. 2b, when a user clicks within one of the active zones of the image map 20, the client system 12 initiates an HTTP connection to the redirect request URL associated with the active zone (e.g. a redirect request) as represented by step 42.

As discussed, the redirect request URL, is a populated representation of an unpopulated redirect request URL 74a-74d from the selected template 64. As such, the redirect request URL includes the core URL 78 to assure that the HTTP connection request routes to the advertisement server 22 and a combination of predetermined template values and populated values useful by the advertisement server 22 to: i) identify the active zone clicked by the user; and ii) uniquely distinguish the instance of the distributed content 16 from other instances of distributed content; and iii) locate, within the redirect database 26, the redirect data associated with the particular advertisement content displayed within the clicked zone.

More specifically, at steps 44 and 46, the advertisement server 22 reads from the redirect table 110 (FIG. 5) of the redirect database 26 the redirect data that associates with: i) the affiliate ID populated into the URL of the redirect request; ii) the campaign ID populated into the URL of the redirect request; iii) the most recent database entry of the instance ID that is populated into the URL of the redirect request; iv) the source IP address from which the redirect request originates; and v) the predetermined zone ID specified in the URL of the redirect request.

A redirect URL (based on the redirect data, determined from the redirect data, looked up from the redirect data, or requested from an external source (such as the placement object 24 using the redirect data) is returned to the client at step 48. The redirect URL may: i) direct the client 14 to a landing document specified by the advertiser (in the case where click through is traced by the advertising server 22) or ii) to the placement object 24 which in turn tracks the click through and redirects the client 14 to the landing document specified by the advertiser

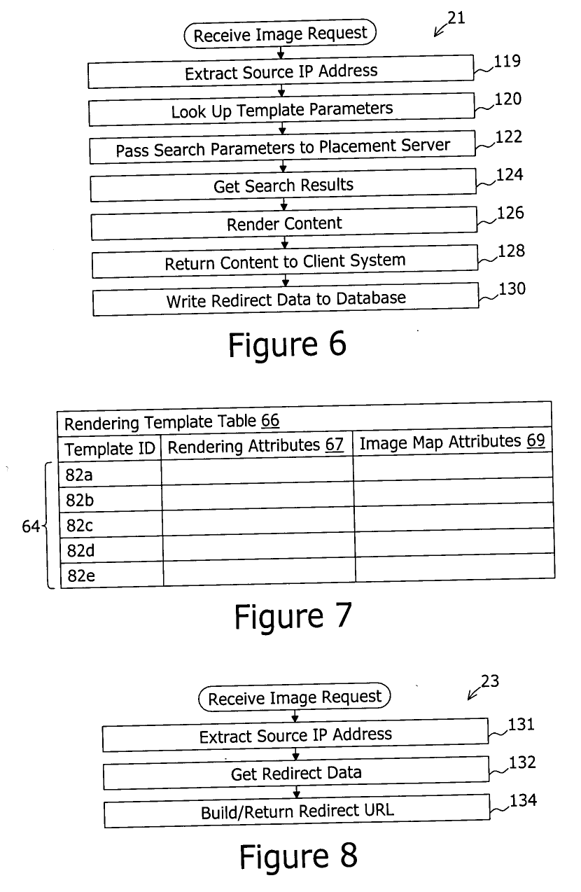

The flow chart of FIG. 6 represents exemplary operation of an advertisement content rendering object 21 of the advertising server 22 in response to receipt of an HTTP connection request including an extension indicating that the connection request is a content request. Referring to Figure, step 119 represents extracting the source IP address from the connection request. Step 120 represents looking up the template parameters of the predetermined rendering template selected by the affiliate and identified (by the template identifier) in the content request.

Step 122 represents passing the search parameter included in the content request and, if appropriate, a format identifier associated with the rendering template 64 to the placement object and step 124 represents obtaining ordered search results.

Step 126 represents rendering the return advertising content in accordance with the rendering attributes 57 and the image map attributes 69 of the template 64 selected by the affiliate and step 128 represents returning the rendered content to the client system 14.

Referring to FIG. 6 in conjunction with FIG. 5, step 130 represents: i) writing the campaign ID value from the content request to the campaign ID table associated with the affiliate ID of the content request—if the campaign ID value does not presently exist in the campaign ID table; ii) writing the instance ID. value from the content request o the instance ID table 106; iii) writing the source IP address of the connection request to the IP address table 108; and iv) writing and populating the redirect data and financial parameter for each zone into a redirect table 110 with a number of records corresponding to the number of active zones in the image map 75.

The flow chart of FIG. 8 represents exemplary operation of a redirect object 23 of the advertising server 22 in response to receipt of an HTTP connection request including an extension indicating that the connection request is a redirect request. Referring to FIG. 8 in conjunction with FIG. 5, step 131 represents extracting the source IP address from the connection request. Step 132 represents looking up the redirect data and financial parameter stored in the redirect table 110 in association with the zone identifier, instance ID, campaign ID, and affiliate ID from the redirect request and the source IP address of the connection request.

Step 134 represents returning a redirect URL to the client system 14. Returning a redirect URL may include returning a redirect URL from the redirect database 26 is so stored. Alternatively, the step may include any of: i) determining and/or building the redirect URL from the redirect data; ii) looking up a redirect URL associated with an aspect of the redirect data; iii) requesting, from an external source (such as the placement object 24, a redirect URL using the redirect data; or iv) a combination thereof.

In summary, it should be appreciated that the systems of the present invention provide a system and method for placing pay for performance advertising content within distributed media content—such as email.

It should also be appreciated that the affiliate selection of a predetermined rendering template and the affiliate's inclusion of the template identifier within the content request URL eliminates any need for the affiliate to register or otherwise pre-communicate it s desired rendering attributes and image map attributes to the advertising server.

It should further yet be appreciated that affiliate's selection of one of a plurality of predetermined search parameters and its inclusion in content request URL eliminates any need for the affiliate to register or otherwise pre-communicate or make the affiliate content available to the advertisement server or the company controlling the advertising server.

Although the invention has been shown and described with respect to certain exemplary embodiments, it is obvious that equivalents and modifications will occur to others skilled in the art upon the reading and understanding of the specification.

For example, the table structures shown in FIGS. 2 and 5 are one exemplary embodiment only. As another example, the URL syntax for the content request URLs and the redirect request URLs is exemplary only, it is envisioned that other URL syntaxes may be used, for example, all information needed for the practice of the present invention could be incorporated into the URL extension.

As another example, the distributed content may readily be content distributed by a web server in response to a client connection request. In which case the web server would include generate (from a selected rendering template) each of a content request URL and image map (as taught in this specification) within the web page. The present invention includes all such equivalents and modifications, and is limited only by the scope of the following claims.

What is claimed is:

1. An advertising system for providing content relevant advertisements to a client system for rendering in association with an instance of distributed content and directing the client system to an advertiser's landing document, the system comprising:
a web server receiving connection requests from client systems, the connection requests being content requests and redirect requests;
each content request comprising: i) a unique identifier distinguishing the instance of distributed content from other instances of distributed content; ii) a template identifier identifying predetermined image map attributes of a predetermined image map defined within the distributed content; and ii) a search parameter;
each redirect request comprising i) the unique identifier distinguishing the instance of distributed content from other instances of distributed content; and ii) an identification of a zone of the image map defined within the distributed content that is selected by a user;
an advertisement content rendering object receiving each content request and in response thereto:
passing the search parameter to a placement object and receiving a plurality of instances of advertising content associated with the search parameter;
returning a rendering of each instance of the plurality of instances of advertising content in accordance the image map attributes associated with the template identifier to the client system;
a redirect database maintaining, in association with those unique identifiers received in a content request, redirect data associated with each instance of advertising content and an indication of the one or more zones of the image map which is associated with the instance of advertising content; and
a redirect object receiving each redirect request and in response thereto:
looking up the redirect data associated with both the unique identifier and the identified zone of the image map and directing the client system to a URL associated with the redirect data.

2. The system of claim 1, wherein the search parameter is a search parameter selected from a group consisting of: i) a search word related to the distributed content; and ii) a search category representing at least two search words related to the distributed content.

3. The system of claim 1, wherein one instance of the advertising content is associated with multiple zones of the image map; and
the redirect data that is associated with such instance of advertising content is associated, in the redirect database, with each zone in which such instance of advertising content is positioned.

4. The system of claim 1, wherein the unique identifier distinguishing the instance of distributed content from other instances of distributed content comprises an affiliate identifier unique to an affiliate generating each instance of the distributed content and an affiliate generated instance identifier distinguishing the instance of distributed content from other instances of distributed content generated by the affiliate.

5. The system of claim 1, wherein:
redirect database only maintains redirect data in association with those unique identifiers received in a content request; and
the advertisement content rendering object writes, data to the redirect database comprising:
i) the unique identifier received in a content request; and
ii) the redirect data associated with the unique identifier.

6. The system of claim 1, wherein
each instance of advertising content is rendered as an instance of text advertising within one or more zones of the image map;
the template identifier further identifies rendering attributes including at least one of text font, font size, font color, and background color; and
the advertisement content rendering object renders each instance of the text advertising in accordance with the attributes in a portion of a single image corresponding to one or more active zones of the image map.

7. The system of claim 6, wherein the search parameter is a search parameter selected from a group consisting of: i) a search word related to the distributed content; and ii) a search category representing at least two search words related to the distributed content.

8. The system of claim 6, wherein one instance of the advertising content is associated with multiple zones of the image map; and
the redirect data that is associated with such instance of advertising content is associated, in the redirect database, with each zone in which such instance of advertising content is positioned.

9. The system of claim 6, wherein the unique identifier distinguishing the instance of distributed content from other instances of distributed content comprises an affiliate identifier unique to an affiliate generating each instance of the distributed content and an affiliate generated instance identifier distinguishing the instance of distributed content from other instances of distributed content generated by the affiliate.

10. The system of claim 6, wherein
redirect database only maintains redirect data in association with those unique identifiers received in a content request; and
the advertisement content rendering object writes, data to the redirect database comprising:
i) the unique identifier received in a content request; and
ii) the redirect data associated with the unique identifier.

11. A method for providing content relevant advertisements to a client system for rendering in association with an instance of distributed content and directing the client computer system to an advertiser's landing document, the method comprising:
receiving a content request from the client computer system, the content request comprising: i) a unique identifier distinguishing the instance of distributed content from other instances of the distributed content; ii) a template identifier identifying predetermined image map attributes of a predetermined image map defined within the distributed content; and ii) a search parameter;
passing the search parameter to a placement object and receiving, in response thereto, a plurality of instances of advertising content associated with the search parameter;
returning a rendering of each instance of the plurality of instances of advertising content in accordance with the image map attributes associated with the template identifier the client system;
writing, to a redirect database, association between the unique identifier and redirect data associated with each instance of advertising content and an indication of the one or more zones of the image in which each instance of advertising content is associated;
receiving a redirect request from the client system, the redirect request comprising i) the unique identifier; and ii) an identification of a zone of the image map; and
looking up the redirect data associated with both the unique identifier and the identified zone of the image map and directing the client system to a URL associated with the redirect data.

12. The method of claim 11, wherein the search parameter is a search parameter selected from a group consisting of: i) a search word related to the distributed content; and ii) a search category representing at least two search words related to the distributed content.

13. The method of claim 11, wherein one instance of the advertising content is associated with multiple zones of the image map; and
the redirect data that is associated with such instance of advertising content is associated, in the redirect database, with each zone in which such instance of advertising content is positioned.

14. The method of claim 11, wherein the unique identifier distinguishing the instance of distributed content from other instances of distributed content comprises an affiliate identifier unique to an affiliate generating each instance of the distributed content and an affiliate generated instance identifier distinguishing the instance of distributed content from other instances of distributed content generated by the affiliate.

15. The method of claim 11, wherein
each instance of advertising content is rendered as an instance of text advertising within one or more zones of the image map;
the template identifier further identifies rendering attributes including at least one of text font, font size, font color, and background color; and
each instance of the text advertising is rendered in accordance with the attributes in a portion of a single image corresponding to one or more active zones of the image map.

16. The method of claim 15, wherein the search parameter is a search parameter selected from a group consisting of: i) a search word related to the distributed content; and ii) a search category representing at least two search words related to the distributed content.

17. The method of claim 15, wherein one instance of the advertising content is associated with multiple zones of the image map; and
the redirect data that is associated with such instance of advertising content is associated, in the redirect database, with each zone in which such instance of advertising content is positioned.

18. The method of claim 15, wherein the unique identifier distinguishing the instance of distributed content from other instances of distributed content comprises an affiliate identifier unique to an affiliate generating each instance of the distributed content and an affiliate generated instance identifier distinguishing the instance of distributed content from other instances of distributed content generated by the affiliate.
